(19) United States
(12) Patent Application Publication
(10) Pub. No.: US 2014/0247107 A1
(43) Pub. Date: Sep. 4, 2014

(54) BARIUM TITANATE SEMICONDUCTOR CERAMIC AND PTC THERMISTOR USING THE SAME

(71) Applicant: MURATA MANUFACTURING CO., LTD., Nagaokakyo-shi (JP)

(72) Inventors: Wataru Aoto, Nagaokakyo-shi (JP); Hayato Katsu, Nagaokakyo-shi (JP); Yasuhiro Nabika, Nagaokakyo-shi (JP)

(73) Assignee: MURATA MANUFACTURING CO., LTD., Nagaokakyo-shi (JP)

(21) Appl. No.: 14/259,295

(22) Filed: Apr. 23, 2014

Related U.S. Application Data
(63) Continuation of application No. PCT/JP2012/069848, filed on Aug. 3, 2012.

(30) Foreign Application Priority Data
Nov. 1, 2011 (JP) 2011-240332

(51) Int. Cl. H01C 7/00; H01C 7/02

(52) U.S. Cl. CPC H01C 7/008; H01C 7/021
USPC 338/22 SD; 252/519.12

(57) ABSTRACT

A barium titanate semiconductor ceramic with positive resistance-temperature characteristics, which is represented by the general formula: BaTiO₃, wherein a Ti site is partially substituted with Zr, and a content ratio of Zr falls within the range of 0.14 to 0.88 mol %, and a PTC thermistor using the same.

### CROSS REFERENCE TO RELATED APPLICATIONS

The present application is a continuation of International application No. PCT/JP2012/069848, filed Aug. 3, 2012, which claims priority to Japanese Patent Application No. 2011-240332, filed Nov. 1, 2011, the entire contents of each of which are incorporated herein by reference.

### FIELD OF THE INVENTION

The present invention relates to a barium titanate semiconductor ceramic with positive resistance-temperature characteristics, and a PTC thermistor using the semiconductor ceramic.

### BACKGROUND OF THE INVENTION

For example, laminate-type semiconductor ceramic elements as described in Patent Document 1 are known as ceramic elements using barium titanate semiconductor ceramic with positive resistance-temperature characteristics.

In the laminate-type semiconductor ceramic element in Patent Document 1, as the ceramic constituting semiconductor ceramic layers, a semiconductor ceramic is used where boron oxide and an oxide of at least one selected from among barium, strontium, calcium, lead, yttrium, and a rare-earth element are contained in a barium titanate semiconductor sintered body, and boron (B) in the boron oxide is added so as to meet 0.001 ≦ B/β ≦0.50 and 0.5 ≦B/(α-β) ≦10.0 (α: the total amount of barium, strontium, calcium, lead, yttrium, and rare-earth element contained in the semiconductor ceramic, β: the total amount of titanium, tin, zirconium, niobium, tungsten, and antimony contained in the semiconductor ceramic) in atomic ratio (see Patent Document 1).

The semiconductor ceramic disclosed in Patent Document 1 is supposed to be able to be fired at temperatures of 1000° C. or lower, and develop excellent PTC characteristics.

However, in recent years, with the progress of sophistication for devices which require overcurrent protection provided by semiconductor ceramics with positive resistance-temperature characteristics, such as cellular phones and PC devices, large current protection has been required which responds to high-capacity/large-current drive.

Further, in order for the semiconductor ceramics with positive resistance-temperature characteristics to meet large current protection, there is a need to have extremely low room-temperature resistance for reducing the power loss in a normal state, and have high withstand voltage.

However, the low room-temperature resistance has a trade-off relationship with securing of high withstand voltage, and it has been difficult to achieve a balance between the both.

Patent Document 1: Japanese Patent Application Laid-Open No. 2000-256062

### SUMMARY OF THE INVENTION

The present invention is intended to solve the problem mentioned above, and an object of the present invention is to provide a barium titanate semiconductor ceramic with positive resistance-temperature characteristics, which is low in room-temperature resistivity, and moreover high in withstand voltage performance, and a PTC thermistor using the semiconductor ceramic.

In order to solve the problem mentioned above, a barium titanate semiconductor ceramic according to the present invention is:

a barium titanate semiconductor ceramic with positive resistance-temperature characteristics, which is represented by the general formula: BaTiO₃,

wherein the Ti site is partially substituted with Zr, and

the content ratio of Zr falls within the range of 0.14 to 0.88 mol %.

The barium titanate semiconductor ceramic according to the present invention preferably contains at least one rare-earth element selected from the group consisting of Y, La, Ce, Pr, Nd, Sm, Eu, Gd, Tb, Dy, Ho, Er, Tm, Yb, and Lu.

The above-mentioned rare-earth element contained makes it possible to ensure that a barium titanate semiconductor ceramic is achieved which has excellent PTC characteristics.

However, it is also possible to make the barium titanate ceramic semiconductive by partially substituting the Ti site (B site) with an element other than the rare-earth element, such as Nb, Sb, and W, in place of using the rare-earth element as a donor.

Furthermore, in a PTC thermistor according to the present invention, the barium titanate semiconductor ceramic according to the present invention is used as a thermistor body with positive resistance-temperature characteristics.

The barium titanate semiconductor ceramic according to the first aspect of the present invention is a barium titanate semiconductor ceramic with positive resistance-temperature characteristics, which is represented by the general formula: BaTiO₃, where the Ti site is partially substituted with Zr, and the content ratio of Zr falls within the range of 0.14 to 0.88 mol %, thus making it possible to lower the room-temperature resistivity while securing high withstand voltage performance.

It is believed that the barium titanate semiconductor ceramic according to the present invention can simultaneously achieve both low resistivity and high withstand voltage performance, because the addition of Zr improves polarization of the barium titanate semiconductor ceramic around room temperature.

Furthermore, the PTC thermistor according to the present invention uses the above-described barium titanate semiconductor ceramic according to the present invention as a thermistor body with positive resistance-temperature characteristics, and thus can provide a highly reliable PTC thermistor with low power consumption.

### BRIEF EXPLANATION OF THE DRAWINGS

FIG. 1 is a front cross-sectional view illustrating the configuration of a PTC thermistor according to an embodiment (Embodiment 1) of the present invention.

FIG. 2 is a diagram showing hysteresis curves of polarization value-electric field for a sample of the sample number 1 and a sample of the sample number 6 in Table 1.

### DETAILED DESCRIPTION OF THE INVENTION

Features of the present invention will be described in more detail with reference to an embodiment of the present invention below.

### EMBODIMENT 1

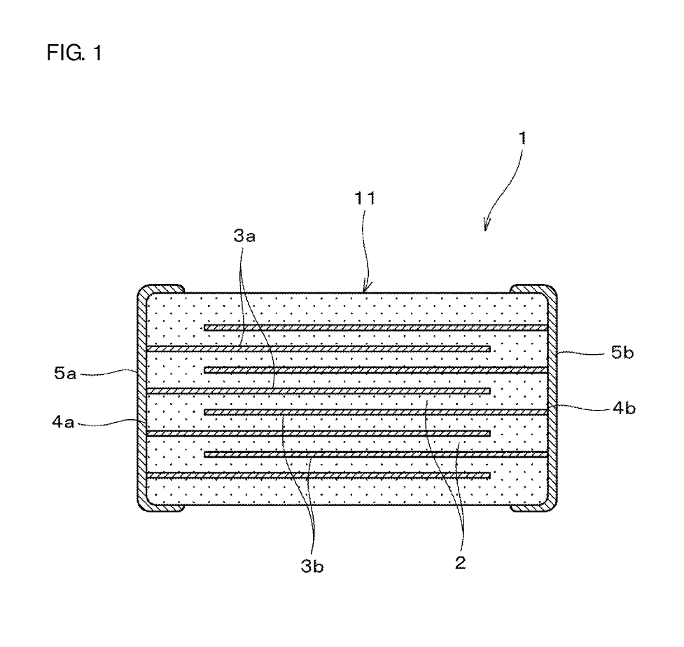

FIG. 1 is a front cross-sectional view illustrating a laminate-type PTC thermistor (positive characteristic thermistor) prepared with the use of a barium titanate semiconductor ceramic according to the present invention.

This PTC thermistor 1 have a structure in which multiple internal electrodes 3a, 3b are stacked with semiconductor ceramic layers 2 composed of semiconductor ceramic with positive resistance-temperature characteristics interposed therebetween, and one (internal electrodes 3a) of the internal electrodes 3a, 3b opposed to each other with the semiconductor ceramic layers 2 interposed therebetween is extracted to one (end surface 4a) of end surfaces 4a, 4b opposed to each other, and the other (internal electrodes 3b) of the internal electrodes 3a, 3b is extracted to the other (end surface 4b) of the end surfaces 4a, 4b opposed to each other; and external electrodes 5a, 5b electrically connected to the internal electrodes 3a, 3b are provided on the end surfaces 4a, 4b of a laminated semiconductor ceramic body 11.

Next, a method for manufacturing the PTC thermistor will be described.

First, respective powders of BaCO₃, TiO₂, Sm₂O₃, and ZrO₂ were prepared as starting raw materials for the semiconductor ceramic with positive resistance-temperature characteristics.

Further, the respective powders of BaCO₃, TiO₂, and Sm₂O₃ were blended in proportions as expressed by the following formula (1), and a predetermined amount of ZrO₂ powder was added thereto.

(Ba_{0.998}Sm_{0.002})ₓTiO₃tm(1)

Next, the powder of the respective raw materials blended was subjected to, with the addition of pure water thereto, mixing and grinding for 16 hours along with zirconia balls. Thereafter, the powder was dried, and subjected to calcination at 1100° C. for 2 hours to obtain a calcined powder.

Then, this calcined powder was, with the addition of an organic binder, a dispersant, and water thereto, mixed for several hours along with zirconia balls, thereby preparing ceramic slurry.

Then, this ceramic slurry was formed into the shape of a sheet by a doctor blade method, and dried to prepare ceramic green sheets of 30 μm in thickness.

Next, a Ni metal powder and an organic binder were dispersed in an organic solvent to prepare a conductive paste for the formation of internal electrodes (Ni internal electrodes).

Thereafter, this conductive paste was printed by a screen printing method onto principal surfaces of the ceramic green sheets prepared in the way described above, thereby providing ceramic green sheets with internal electrodes printed. In printing the conductive paste, the conductive paste was printed so that the sintered internal electrodes were 0.5 to 2 μm in thickness.

Next, the ceramic green sheets with the internal electrodes printed were stacked to have 24 sheets of internal electrodes in total, and have a distance (that is, the thickness of the ceramic green sheet) of 30 μm between the internal electrodes. Furthermore, five of the ceramic green sheets with no internal electrode printed were placed on each of the top and bottom, and subjected to pressure bonding to prepare a pressure-bonded laminated body.

Then, this pressure-bonded laminated body was cut to obtain a raw chip so that an element of 2.0 mm in length, 1.2 mm in width, and 1.0 mm in thickness was obtained after firing.

Thereafter, this raw chip was degreased by heat treatment under the condition of 300° C. for 12 hours in the atmosphere, and then subjected to firing for 2 hours at 1180° C. to 1240° C. under a reducing atmosphere of N₂/H₂, thereby providing a ceramic sintered body.

Next, the ceramic sintered body obtained was coated with glass, and subjected to a heat treatment at 700° C. in the atmosphere to form a glass layer for improving atmosphere resistance and weather resistance and to carry out reoxidation of the ceramic sintered body.

Next, barrel polishing was carried out to expose the internal electrodes at both end surfaces of the ceramic sintered body, and Cr, NiCu, and Ag were then sputtered in this order onto the both end surfaces of the ceramic sintered body to form electrodes.

Then, Sn plating was deposited by electrolytic plating to form external electrodes on the surfaces of the electrodes, thereby providing a laminate-type PTC thermistor (sample) configured as shown in FIG. 1.

In this embodiment, the zirconia balls are used for mixing and grinding the raw materials as described above, and Zr is mixed in as contamination from the zirconia balls.

Therefore, while the ZrO₂ powder is added in a range such that the content ratio of Zr in the barium titanate semiconductor ceramic is 0.00 mol % (sample number 1) to 1.00 mol % (sample number 7) as shown in Table 1 in this embodiment, the actual content ratio of Zr in the barium titanate semiconductor ceramic has a value including Zr derived from contamination from the zirconia balls.

The sample of the sample number 1 in Table 1 is a sample with no ZrO₂ powder added thereto, but contains Zr derived from contamination from the zirconia balls in a proportion of 0.05 mol %. In other words, the 0.05 mol % of Zr in the sample of the sample number 1 in Table 1 is all derived from the zirconia balls.

In addition, in the case of the samples of the sample numbers 2 to 7 with the ZrO₂ powder added thereto, the contents of Zr in the obtained barium titanate semiconductor ceramics have values including both Zr derived from the added ZrO₂ powder and Zr derived from contamination from the zirconia balls, as shown in Table 1.

In other words, the difference between the value of the Zr content (mol %) in Table 1 and the value of Zr (mol %) derived from the added ZrO₂ powder refers to Zr derived from contamination.

It is to be noted that ICP-AES was used for quantifying Zr in this embodiment.

Furthermore, the room-temperature resistivity (Ω·cm) and withstand voltage (V/mm) were investigated for the samples of the sample numbers 1 to 7 prepared in this way. The results are shown in Table 1.

TABLE 1

| | | Zr derived | | | |
|---|---|---|---|---|---|
| | | from ZrO₂ | Zr derived | Room- | |
| | Zr | Powder | from | Temperature | Withstand |
| Sample | Content | Added | Contamination | Resistivity | Voltage |
| Number | (mol %) | (mol %) | (mol %) | (Ω · cm) | (V/mm) |
| 1* | 0.05 | 0.00 | 0.05 | 21.5 | 550 |
| 2 | 0.14 | 0.10 | 0.04 | 15.2 | 550 |
| 3 | 0.26 | 0.20 | 0.06 | 14.1 | 550 |
| 4 | 0.48 | 0.40 | 0.08 | 13.6 | 550 |
| 5 | 0.65 | 0.60 | 0.05 | 16.1 | 550 |
| 6 | 0.88 | 0.80 | 0.08 | 16.2 | 550 |
| 7* | 1.07 | 1.00 | 0.07 | 25.8 | 550 |

It is to be noted that the samples of the sample numbers marked with * in Table 1 refer to samples as comparative examples with the Zr content ratios outside the scope of the present invention.

As shown in Table 1, it was confirmed that in the case of the sample of the sample number 1 with the Zr content of 0.14 mol % or less, the room-temperature resistivity is high at 21.5 Ω·cm, and also in the case of the sample of the sample number 7 with the high Zr content of 0.88 mol % or more, which is 1.07 mol %, the room-temperature resistivity is high at 25.8 Ω·cm.

In contrast, in the case of the samples of the sample numbers 2, 3, 4, 5, and 6 containing Zr in the range of 0.14 to 0.88 mol %, which meet the requirements of the present invention, the room-temperature resistivity was able to be reduced by approximately 40% as compared with the conventional cases while maintaining the withstand voltage comparable to the conventional cases.

In addition, it was confirmed that the withstand voltage can achieve 550 V/mm in each case of the samples of the sample numbers 1 to 7.

From this result, it is understood that the low resistivity and high withstand voltage can be achieved simultaneously by containing Zr in the range of 0.14 to 0.88 mol % and partially substituting the Ti site with Zr.

It is to be noted that the amount of Zr derived from the zirconia balls fell within the range of 0.04 to 0.08 mol % in the respective samples prepared according to the embodiment described above. Accordingly, depending on the condition for mixing and grinding in the production step, a semiconductor ceramic containing an intended amount of Zr can be produced by adding the Zr raw material obtained by subtracting, from the target Zr content, the amount of Zr derived from the zirconia balls.

In the present invention, although the mechanism that can reduce the room-temperature resistivity with the barium titanate semiconductor ceramic containing therein a predetermined proportion of Zr has not been necessarily clarified, it is assumed that Zr contained in the barium titanate semiconductor ceramic will improve the polarization of the barium titanate semiconductor ceramic at room temperature to thereby enhance the effect of compensating interface charges trapped at grain boundaries (reducing the grain-boundary energy barrier), thus lowering the room-temperature resistivity.

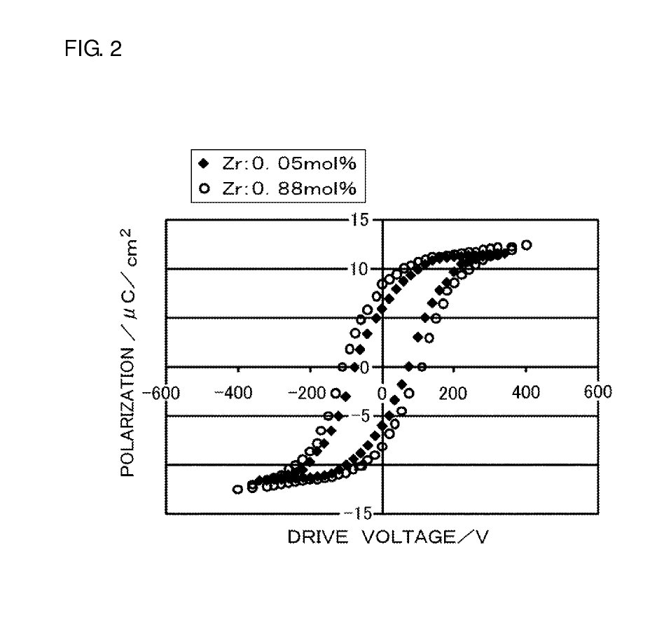

In this regard, FIG. 2 shows hysteresis curves of polarization value-electric field for the sample of the sample number 1 (Zr: 0.05 mol %) and the sample of the sample number 6 (Zr: 0.88 mol %) in Table 1.

As shown in FIG. 2, it is understood that in the case of the sample of the sample number 6 with Zr: 0.88 mol %, the residual polarization value is increased to improve the polarization, as compared with the sample of the sample number 1 with Zr: 0.05 mol %. This agrees with the idea that Zr contained in a predetermined range improves the polarization at room temperature and lowers the grain-boundary energy barrier to lower the resistance.

It is to be noted that while Sm (Sm₂O₃ powder as a raw material form) is used as the rare-earth element for a donor in the embodiment described above, it is also possible to use other rare-earth elements such as Y, La, Ce, Pr, Nd, Eu, Gd, Tb, Dy, Ho, Er, Tm, Yb, and Lu.

In addition, the type and amount of the donor are also able to be changed in general ranges, and in such cases, similar effects can be also achieved.

In addition, it is also possible to make the barium titanate ceramic semiconductive by substituting the Ti site (B site) with an element other than the rare-earth element, such as Nb, Sb, and W, in place of using the rare-earth element as a donor, and also in the case of using such a barium titanate ceramic, the present invention can be applied to achieve a reduction in resistance.

It is to be noted that while the ZrO₂ powder is used as the Zr raw material in the embodiment described above, it is also possible to add ZrO₂, for example, in the form of a sol dispersed in an aqueous solution, rather than in the form of a powder, and it is also possible to use other forms.

In addition, while the laminate-type PTC thermistor has been taken as an example and explained in the above-described embodiment, it is also possible to apply the semiconductor ceramic according to the present invention to, for example, a single-plate PTC thermistor structured to have electrodes formed on both principal surfaces of a plate-like semiconductor ceramic body.

In the above-described embodiment, while the external electrodes are formed by sputtering Cr, NiCu, and Ag in this order and further Sn plating is deposited by electrolytic plating on the surfaces of the external electrodes, the configuration of the external electrodes is not particularly limited, and it is possible to have various configurations.

In addition, the barium titanate semiconductor ceramic and PTC thermistor according to the present invention are not limited to the above-described embodiment also in other respects, and various applications and modifications can be made within the scope of the present invention.

### DESCRIPTION OF REFERENCE SYMBOLS

1 PTC thermistor

2 semiconductor ceramic layer

3a, 3b internal electrode

4a, 4b end surfaces of laminated semiconductor ceramic body, which are opposed to each other

5a, 5b external electrode

11 laminated semiconductor ceramic body

1. A barium titanate semiconductor ceramic with positive resistance-temperature characteristics, which is represented by the general formula: BaTiO₃,
wherein a Ti site is partially substituted with Zr, and
a content ratio of Zr falls within a range of 0.14 to 0.88 mol %.

2. The barium titanate semiconductor ceramic according to claim 1, wherein the semiconductor ceramic contains at least one rare-earth element selected from the group consisting of Y, La, Ce, Pr, Nd, Sm, Eu, Gd, Tb, Dy, Ho, Er, Tm, Yb, and Lu.

3. A PTC thermistor comprising:
a thermistor body having a plurality semiconductor ceramic layers and plurality of internal electrode layers that are alternately stacked;
a first external electrode on a first surface of the thermistor body; and
a second external electrode on a second surface of the thermistor body,
wherein a first set of the plurality of internal electrode layers are electrically connected to the first external electrode,
wherein a second set of the internal electrodes are electrically connected to the second external electrode, and
wherein at least one of the semiconductor ceramic layers of the thermistor body comprise the barium titanate semiconductor ceramic according to claim 1.

4. The PTC thermistor according to claim 3, wherein all the semiconductor ceramic layers of the thermistor body comprise the barium titanate semiconductor ceramic.

5. The PTC thermistor according to claim 3, wherein the first and second surfaces are opposed surfaces.

6. A PTC thermistor comprising:
a body having at least one semiconductor ceramic layer;
a first external electrode on a first surface of the body; and
a second external electrode on a second surface of the body,
wherein the at least one semiconductor ceramic layer comprises the barium titanate semiconductor ceramic according to claim 1.

7. The PTC thermistor according to claim 6, wherein the first and second surfaces are opposed surfaces.
